(19) United States
(12) Patent Application Publication
(10) Pub. No.: US 2011/0128320 A1
(43) Pub. Date: Jun. 2, 2011

(54) INK RECEIVING DEVICE FOR INK JET PRINTER

(75) Inventor: Hiroki Sezaki, Zama-shi (JP)

(73) Assignee: KABUSHIKI KAISHA TOKYO KIKAI SEISAKUSHO, Tokyo (JP)

(21) Appl. No.: 12/913,884

(22) Filed: Oct. 28, 2010

(30) Foreign Application Priority Data
Nov. 30, 2009 (JP) 2009-271547

(51) Int. Cl. B41J 2/165

(52) U.S. Cl. 347/22

(57) ABSTRACT

An ink receiving device C for an ink jet printer includes: an ink receptacle which receives ink discharged from nozzles of ink jet heads; and a support member which supports the ink receptacle in a manner to enable the ink receptacle to move horizontally. The ink receptacle is enabled by the support member to move horizontally to three positions including: a standby position at which the ink receptacle does not disturb the ink jet heads from printing on a print medium; an ink receiving position which is below the ink discharging surfaces of the ink jet heads and at which the ink receptacle receives ink discharged for a purpose other than printing; and a maintenance position which is different from the ink receiving position and the standby position and at which a maintenance work of the ink receptacle is performed.

### CROSS-REFERENCE TO RELATED APPLICATION

The present application relates to subject matter contained in Japanese Patent Application No. 2009-271547, filed on Nov. 30, 2009, all of which are expressly incorporated herein by reference in their entirety.

### BACKGROUND OF THE INVENTION

1. Field of the Invention

The present invention relates to an ink receiving device provided for receiving ink discharged for a purpose other than printing from an ink jet head of a line head type ink jet printer which prints on a running print medium by discharging ink from an ink jet head of which ink discharging surface is faced with the top surface of the print medium.

2. Description of the Related Art

Ink jet type printers include a serial head type printer which can print across the entire width of a print medium by moving a relatively small-sized ink jet head in the widthwise direction of the print medium and moving (running) the print medium in its lengthwise direction, and a line head type printer which has an ink jet head unit having a length corresponding to the width of a print medium and hence, without moving the ink jet head unit, can print across the entire width of a print medium by moving (running) the print medium in its lengthwise direction. Since the line head type printer needs not move its head in the widthwise direction of the print medium, it is advantageous in that it can print faster than the serial head type printer.

There is a limitation on the width of a print medium that can be covered by one ink jet head from viewpoints of manufacturing accuracy and manufacturing costs of the ink jet head, and it is often the case with the line head type printer for printing on a wide print medium that a plurality of ink jet heads having an arbitrary length are arranged side by side in the widthwise direction of the print medium to serve as one ink jet head unit to cover the width of the print medium. When a plurality of ink jet heads are arranged side by side in the widthwise direction of the print medium to serve as one ink jet head unit, the width that can be printed by one ink jet head is shorter than the width of its casing. Therefore, in order that no discontinuity may occur in the print at the boundary between a head and a head provided side by side in the widthwise direction of the print medium, the ink jet heads constituting the ink jet head unit are staggered in the moving direction of the print medium, such that the casings of the ink jet heads overlap partially in the widthwise direction of the print medium and hence no discontinuity occurs in the print.

In color printing, generally, four colors of inks, namely, cyan, magenta, yellow, and black are overprinted. Hence, when performing color printing by the line head type printer described above, ink jet head units provided individually for discharging different colors of inks are arranged side by side in the moving direction of the print medium. These plurality of ink jet heads and ink jet head units are arranged in the printer with accurate positioning.

The nozzles of an ink jet head from which ink is discharged have a very small diameter (several ten micron meters), and might bring about ink discharge failure due to mixing of foreign matters and air bubbles. Further, discharge failure might also occur after a long time of absence of ink discharge from the nozzles, because the solvent in the ink in the nozzles has evaporated to increase the ink viscosity. Therefore, in order to avoid ink discharge failure, it is indispensable to perform maintenance of the ink jet heads at an arbitrary timing such as before printing, and as needed, during printing or after printing, etc.

In a maintenance work of an ink jet head, an operation called ink purge, preliminary discharge, spitting, etc. (hereinafter these three will be described as “ink purge”) is performed in which ink is discharged from the nozzles for a purpose other than printing. This ink purge can remove foreign matters, air bubbles, and viscosity-thickened ink in the nozzles, which are the cause of ink discharge failure.

The serial head type printer, which performs printing by moving its ink jet head, can perform ink purge toward an ink receptacle if the printer is configured to be able to move the ink jet head to above the ink receptacle that exists at a fixed position.

On the other hand, in the line head type printer, the ink jet head unit having a length corresponding to the width of a print medium as described above is larger-sized than a serial head type inkjet head. Therefore, the line head type printer includes a larger number of ink pipes and electrical wirings connected, and hence requires a complex moving mechanism in order to move the ink jet heads to above an ink receptacle existing at a fixed position, which is costly and increases the likelihood of device breakdown. Moreover, the ink jet heads of the line head type printer are positioned with accuracy within the printer, and cannot be easily returned accurately to the original positions for performing printing after being moved to above the ink receptacle.

Hence, Specification of Japanese Patent No. 3828411 discloses an image forming apparatus which includes: a liquid droplet discharging means (ink jet head) for printing an image by discharging liquid droplets onto a recording medium; a discharge recovery process unit which performs a process for recovering (maintaining) the discharging performance; a recording medium moving means for enabling the recording medium to be moved to a first position at which the recording medium can face the liquid droplet discharging means and to a second position different from the first position; and a discharge recovery process unit moving means for enabling the discharge recovery process unit to be moved to the first position at which the unit can face the liquid droplet discharging means and to a third position different from the first position.

In the image forming apparatus disclosed in Specification of Japanese Patent No. 3828411, during printing (described as “image printing” in Specification of Japanese Patent No. 3828411), the discharge recovery process unit is retracted to the third position (retracted position) at which the discharge recovery process unit does not disturb the head from performing printing. When transitioning to the state for discharge recovery, a platen and guide rollers are lifted downward to lower a continuous paper sandwiched between the platen and the guide rollers to the second position at which the paper does not disturb the movement of the discharge recovery process unit, and then, the discharge recovery process unit is moved horizontally from the third position (retracted position) to the first position at which the discharge recovery process unit faces the head to start the discharge recovery process. When the predetermined discharge recovery process is completed, the discharge recovery process unit is moved to the third position (retracted position) , the guide rollers are moved to move the print surface of the continuous paper to the first position at which the paper can face the head, and the platen is also moved to the first position to abut on and contact the back surface of the continuous paper. Further, Specification of Japanese Patent No. 3828411 describes ink purge (described as “spitting process” in Specification of Japanese Patent No. 3828411) for forcibly discharging ink into a dedicated ink receptacle, as one example of the discharge recovery process performed by the discharge recovery process unit.

When printing on a continuous paper, generally, an in-feed unit which sends forth the continuous paper by tensioning it is provided at the upstream of the printing unit (ink jet head in the case of ink jet printing), and a paper feeding unit which supports a paper web is provided at the upstream of the in-feed unit. An out-feed unit which sends forth the printed continuous paper to an after-treatment unit is provided at the downstream of the printing unit, and the after-treatment unit cuts the printed continuous paper into a certain size, and lets out the printed product by folding the paper as needed. In this way, in the printing on a continuous paper, a series of printing devices from the paper feeding unit to the after-treatment unit are lined up in the running direction of the continuous paper. A control panel for controlling the series of printing devices, motors for driving rollers of the in-feed unit and the out-feed unit, ducts for delivering compressed air, which is the drive source of an actuator, and ducts for delivering ink, etc. are provided at roughly one side (drive side) of the continuous paper in its widthwise direction, whereby it is easy for a worker to operate the printing devices by moving along the printing devices at the other side (operation side) of the continuous paper in its widthwise direction.

### SUMMARY OF THE INVENTION

In the image forming apparatus disclosed in Specification of Japanese Patent No. 3828411,the discharge recovery process unit moves by means of the discharge recovery process unit moving means to be positioned at the first position at which the discharge recovery process unit faces the head and the third position (retracted position) at which the discharge recovery process unit does not disturb the head from performing printing during printing.

However, when the discharge recovery process unit is at the first position, the discharge recovery process unit faces the head, which is unsuitable for maintenance work such as cleaning the discharge recovery process unit, etc., because the head facing the discharge recovery process unit stands as an obstacle.

On the other hand, when the discharge recovery process unit is at the third position, it is possible to perform maintenance work, because the third position is a position at which the discharge recovery process unit does not disturb the head from performing printing and hence the discharge recovery process unit at least does not face the head. However, when the third position is defined at the operation side of the continuous paper in its widthwise direction, the discharge recovery process unit is positioned at the operation side of the printing unit all the time during printing and disturbs the worker from moving along the series of printing devices including the printing unit and operating the devices.

When the third position is defined at the drive side of the continuous paper in its widthwise direction, work efficiency for performing maintenance work for the discharge recovery process unit is extremely poor because motors for driving the rollers of the in-feed unit and the adjoining out-feed unit, wirings for connecting the motors to the control panel, ducts for accommodating wirings connected to the ink jet head of the printing unit and ink pipes, etc. are provided at the drive side.

Moreover, when the discharge recovery process unit is an ink receptacle for receiving ink discharged by ink purge, if the ink adhered to the ink receptacle is left un-disposed for a long time, the solvent in the ink might evaporate to get the ink firmly fixed to the ink receptacle. Therefore, it is necessary to perform maintenance work such as cleaning, etc. frequently. Hence, it has been demanded to realize a device which can improve the work efficiency of the maintenance work.

The present invention was made in view of the existence of the various problems described above, and an object of the present invention is to provide an ink receiving device for a line head type ink jet printer, which, during printing, can move an ink receptacle to a position at which the ink receptacle does not disturb a worker from performing operations accompanying the printing, and which, during maintenance work such as cleaning the ink receptacle, can move the ink receptacle to a position at which the work can be easily performed.

An ink receiving device for an ink jet printer according to the present invention is an ink receiving device for an ink jet printer, provided for receiving ink discharged for a purpose other than printing from an ink jet head of a line head type ink jet printer which prints on a running continuous print medium by discharging ink from the ink jet head of which ink discharging surface is faced with a top surface of the print medium, the ink receiving device comprising: an ink receptacle which receives ink discharged from a nozzle of the ink jet head; and a support member which supports the ink receptacle in a manner to enable the ink receptacle to move horizontally, wherein the ink receptacle is enabled by the support member to move horizontally to three positions including: a standby position at which the ink receptacle does not disturb the ink jet head from printing on the print medium; an ink receiving position which is below the ink discharging surface of the ink jet head, and at which the ink receptacle receives ink discharged for a purpose other than printing; and a maintenance position which is different from the ink receiving position and the standby position, and at which a maintenance work of the ink receptacle is performed.

In the ink receiving device for the ink jet printer according to the present invention, the standby position and the maintenance position may exist on different sides of the print medium in its widthwise direction, oppositely with respect to a running path of the print medium.

In the ink receiving device for the ink jet printer according to the present invention, the support member may include at least: a fixed member which is fixed inside the ink jet printer; and a moving member which is able to move by being guided by the fixed member and on which the ink receptacle is attached.

The ink receiving device for the ink jet printer according to the present invention may comprise ink receptacle moving unit which moves the ink receptacle at least between the ink receiving position and the standby position.

According to the present invention, it is possible to provide an ink receiving device for an ink jet printer, which, during printing, can move an ink receptacle to a position at which the ink receptacle does not disturb a worker from performing operations accompanying the printing, and which, during maintenance work such as cleaning the ink receptacle, can move the ink receptacle to a position at which the work can be easily performed.

### BRIEF DESCRIPTION OF THE DRAWINGS

FIG. 1A is a schematic sectional diagram of a printer equipped with an ink receiving device according to an embodiment, showing a sectional view orthogonal to the running direction of a continuous paper, where ink receptacles exist at a standby position.

FIG. 1B is a sectional diagram of FIG. 1A taken at the height of X-X and seen with the sight line directed to the direction of arrows.

FIG. 2A is a schematic sectional diagram of the printer equipped with the ink receiving device according to the present embodiment, showing a sectional view orthogonal to the running direction of the continuous paper, where ink receptacles exist at an ink receiving position.

FIG. 2B is a sectional diagram of FIG. 2A taken at the height of X-X and seen with the sight line directed to the direction of arrows.

FIG. 3A is a schematic sectional diagram of the printer equipped with the ink receiving device according to the present embodiment, showing a sectional view orthogonal to the running direction of the continuous paper, where ink receptacles exist at a maintenance position. FIG. 3B is a sectional diagram of FIG. 3A taken at the height of X-X and seen with the sight line directed to the direction of arrows.

FIG. 4 is a sectional diagram of FIG. 2A taken at the position of Y-Y and seen with the sight line directed to the direction of arrows.

FIG. 5 is a sectional diagram of FIG. 1A taken at the height of Z-Z and seen with the sight line directed to the direction of arrows.

FIG. 6 is a diagram showing a portion at which a frame of a support member and a leading end of a rod of an air cylinder of a first ink receptacle moving unit are attached, where a sub-diagram (a) shows FIG. 2A seen with the sight line directed to the direction of an arrow AX, and a sub-diagram (b) is a sectional diagram of the sub-diagram (a) taken at the position of AY-AY and seen with the sight line directed to the direction of arrows, and FIG. 6 shows a state in which a linking bar is at a linking position.

FIG. 7 is a diagram showing a portion at which the frame of the support member and the leading end of the rod of the air cylinder of the first ink receptacle moving unit are attached, and showing a state in which the linking bar of FIG. 6 is at a releasing position, where a sub-diagram (b) is a sectional diagram of a sub-diagram (a) taken at the position of AY-AY and seen with the sight line directed to the direction of arrows.

FIG. 8 is a schematic sectional diagram of a printer showing an embodiment employing a second ink receptacle moving unit, taken orthogonally to the running direction of a continuous paper.

### DETAILED DESCRIPTION OF THE INVENTION

Preferred embodiments for carrying out the invention will now be described with reference to the drawings. The following embodiments are not intended to limit the inventions set forth in the claims, and all the combinations of features explained in the embodiments are not necessarily indispensable for the means for solving provided by the invention.

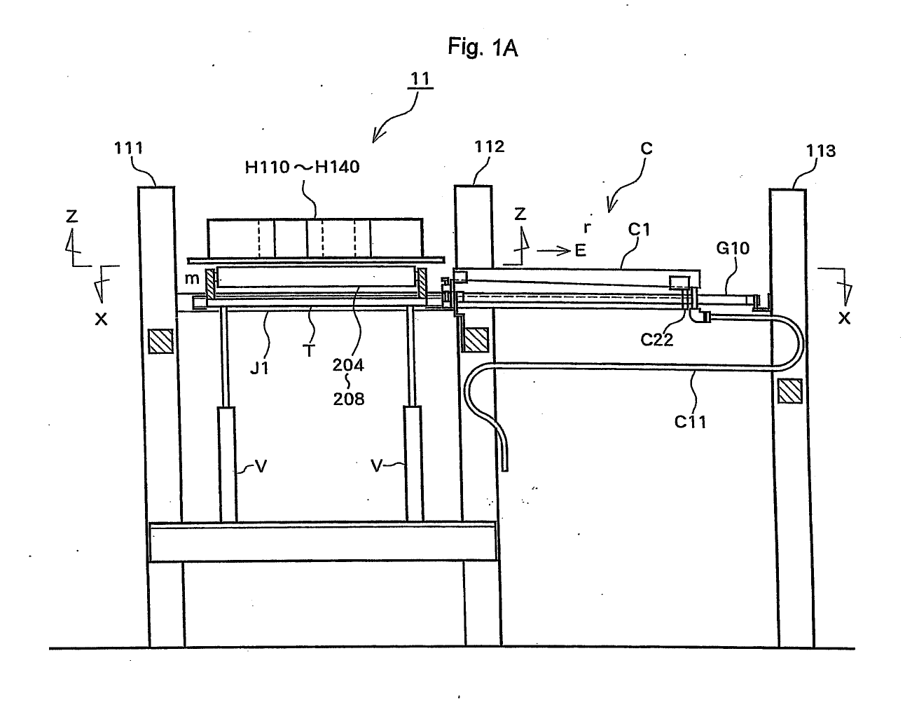

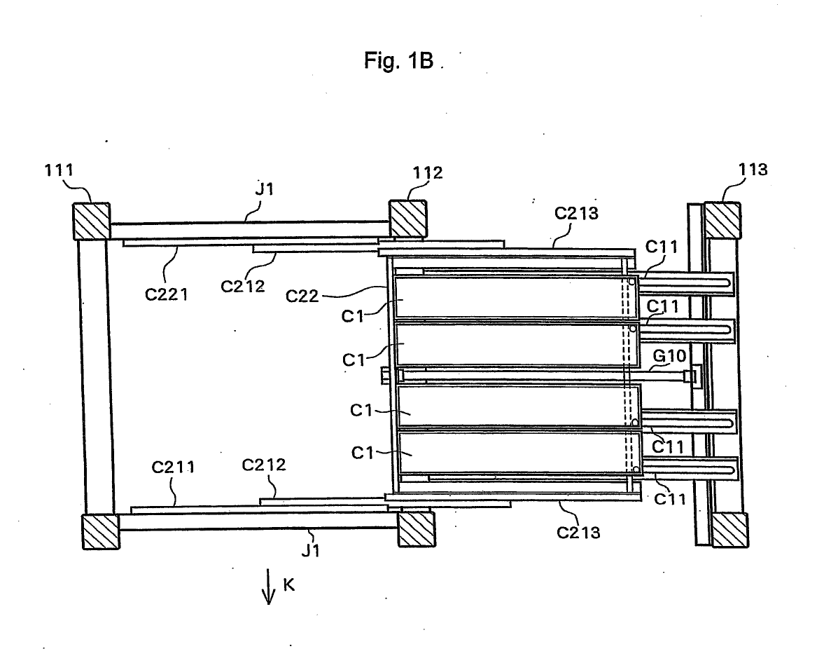

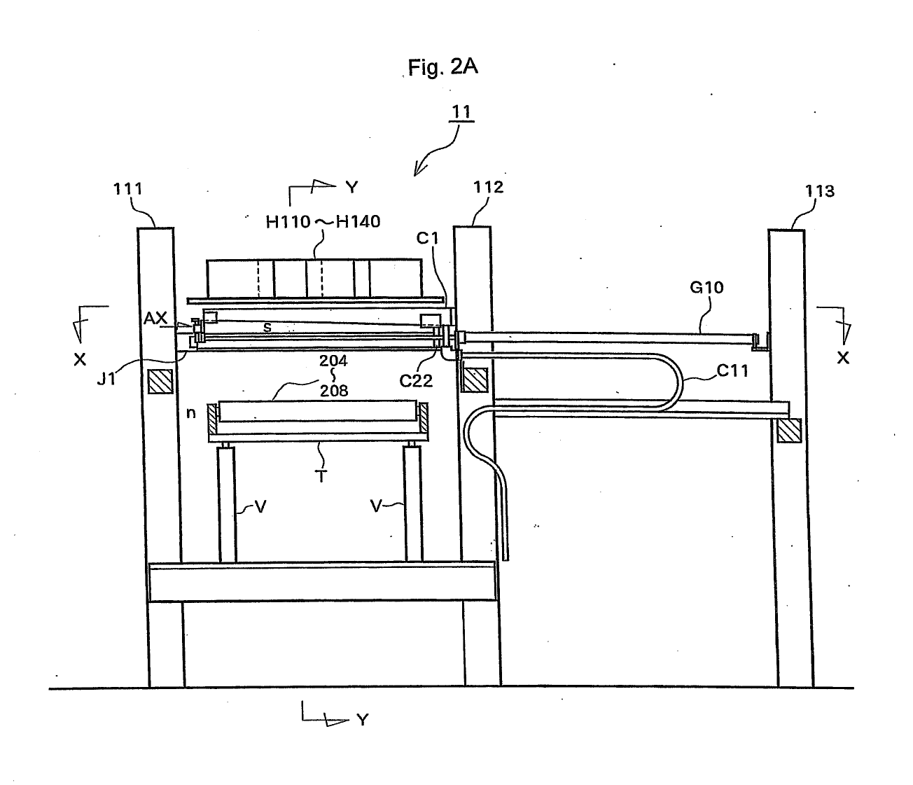

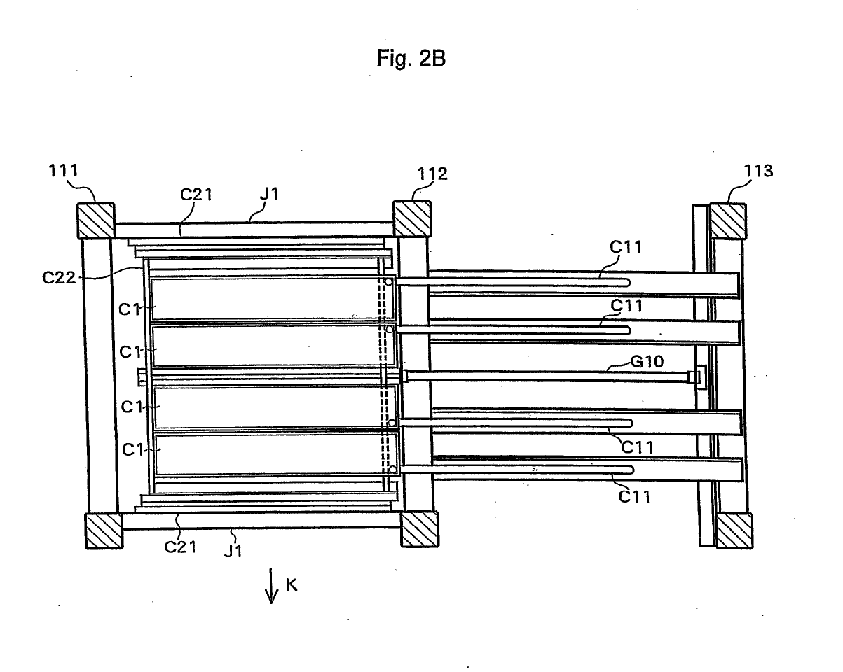

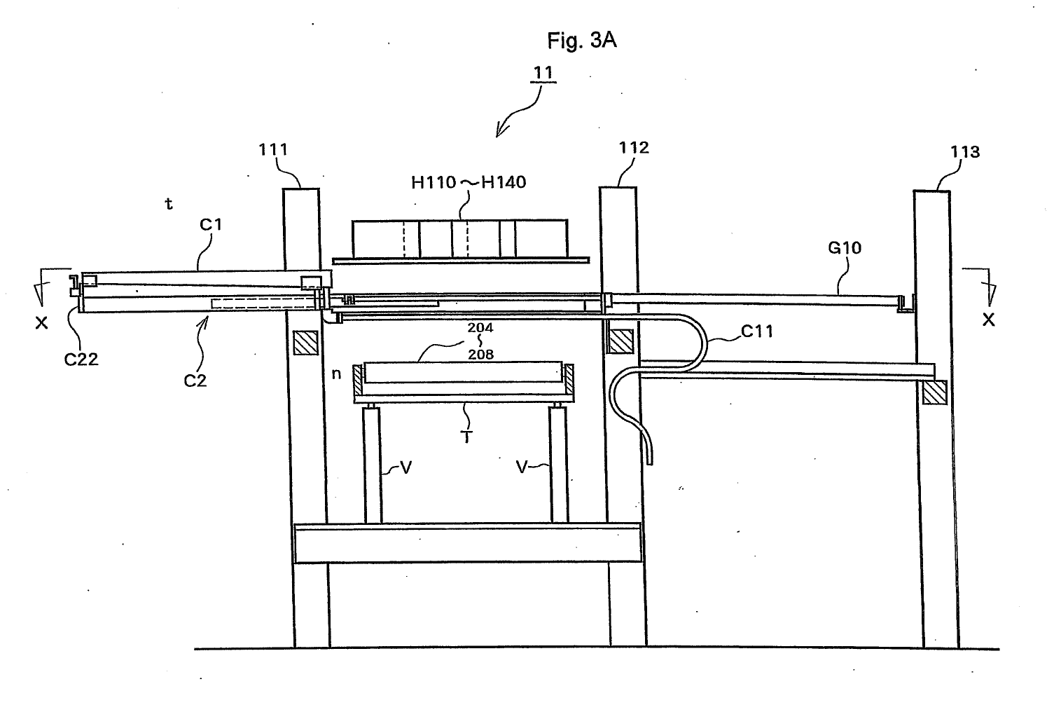

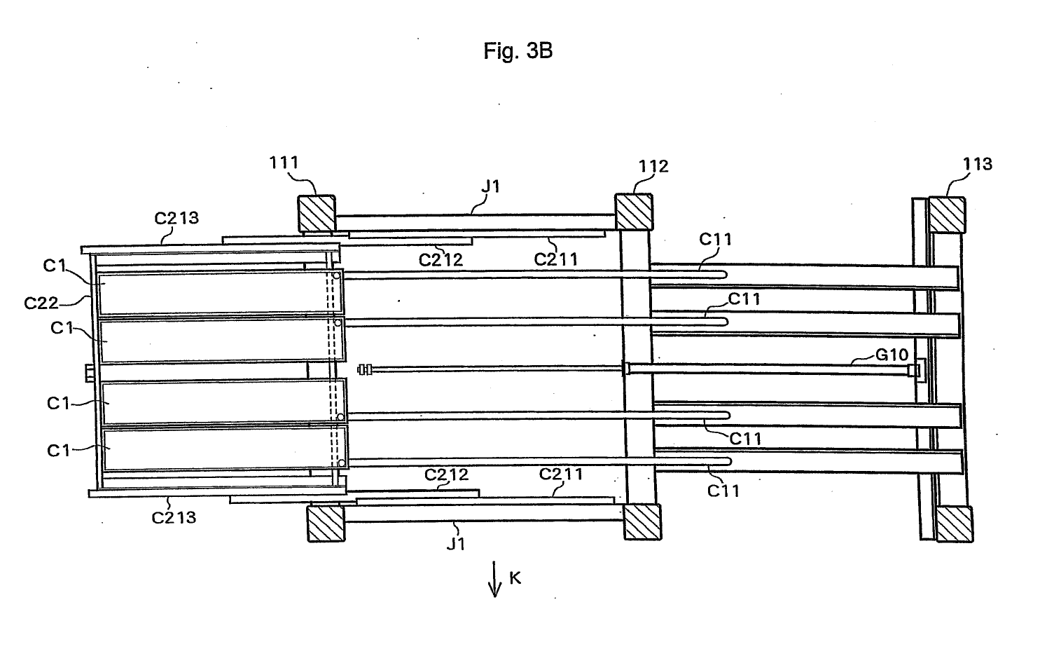

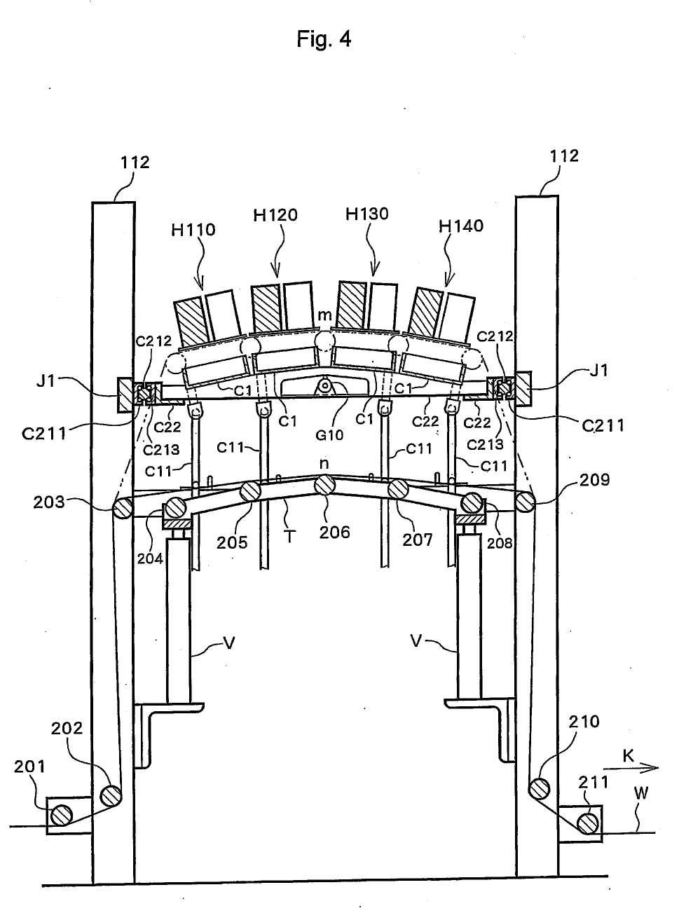

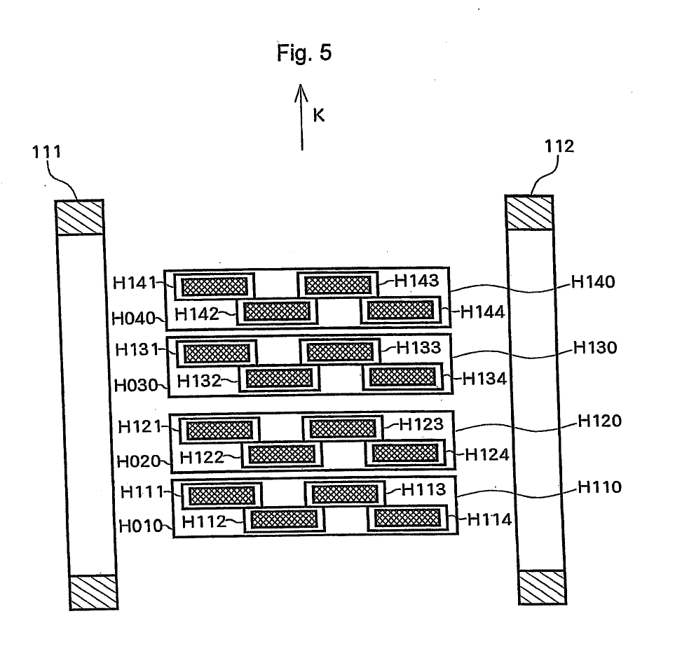

FIG. 1A to FIG. 5 are diagrams schematically showing a line head type printer (hereinafter described as printer 11) which includes: an ink receiving device for an ink-jet-printer use according to the present embodiment; and a printing unit capable of performing four color printing (color printing). FIG. 1A and FIG. 1B are diagrams in which ink receptacles C1 are at a standby position r. FIG. 2A and FIG. 2B are diagrams in which the ink receptacles C1 are at an ink receiving position s. FIG. 3A and FIG. 3B are diagrams in which the ink receptacles C1 are at a maintenance position t. FIG. 1A, FIG. 2A, and FIG. 3A are schematic sectional diagrams showing sectional views orthogonal to the running direction of a continuous paper W. FIG. 1B, FIG. 2B, and FIG. 3B are sectional diagrams of FIG. 1A, FIG. 2A, and FIG. 3A taken at the height of X-X and seen with the sight line directed to the direction of arrows. However, guide rollers 201 to 209 and a frame T are not illustrated in FIG. 1B, FIG. 2B, and FIG. 3B. FIG. 4 is a sectional diagram of FIG. 2A taken at the position of Y-Y and seen with the sight line directed to the direction of arrows, and schematically shows an inner view of the printer 11. FIG. 5 is a sectional diagram of FIG. 1A taken at the height of Z-Z and seen with the sight line directed to the direction of arrows, and shows a view, as seen from below, of ink discharging surfaces F of four ink jet head units H110 to H140 for discharging inks of different colors.

The printer 11 is mounted with an ink jet head unit H110 for discharging cyan ink, an ink jet head unit H120 for discharging magenta ink, an ink jet head unit H130 for discharging yellow ink, and an ink jet head unit H140 for discharging black ink, which are provided in an unillustrated bracket provided on a pair of left and right frames 111 and 112 which are provided in parallel with the running direction of a continuous paper W, which is a print medium. The ink jet head unit H110 for discharging cyan ink of the printer 11 is configured by attaching ink jet heads H111 to H114 shorter than the width of the continuous paper W on a support plate H010 such that the ink jet heads H111 to H114 are arranged side by side in the widthwise direction of the continuous paper. Holes are opened in the support plate H010 to match the ink discharging surfaces F of the ink jet heads H111 to H114 respectively, such that the ink discharging surfaces F face the top surface of the continuous paper W in parallel.

Like the ink jet head unit H110, the ink jet head unit H120 for discharging magenta ink is configured by attaching ink jet heads H121 to H124 shorter than the width of the continuous paper W on a support plate H020 such that the ink jet heads H121 to H124 are arranged side by side in the widthwise direction of the continuous paper W. The ink discharging surfaces F of the ink jet heads H121 to H124 face the top surface of the continuous paper W in parallel. The ink jet head unit H120 is provided to adjoin the ink jet head unit H110 at the downstream side in the running direction of the continuous paper W.

Likewise, the ink jet head unit H130 for discharging yellow ink is configured by attaching ink jet heads H131 to H134 shorter than the width of the continuous paper W on a support plate H030 such that the ink jet heads H131 to H134 are arranged side by side in the widthwise direction of the continuous paper W. The ink discharging surfaces F of the ink jet heads H131 to H134 face the top surface of the continuous paper W in parallel. The ink jet head unit H130 is provided to adjoin the ink jet head unit H120 at the downstream side in the running direction of the continuous paper W.

Likewise, the ink jet head unit H140 for discharging black ink is configured by attaching ink jet heads H141 to H144 shorter than the width of the continuous paper W on a support plate H040 such that the ink jet heads H141 to H144 are arranged side by side in the widthwise direction of the continuous paper W. The ink discharging surfaces F of the ink jet heads H141 to H144 face the top surface of the continuous paper Win parallel. The ink jet head unit H140 is provided to adjoin the ink jet head unit H130 at the downstream side in the running direction of the continuous paper W.

In FIG. 5, the hatched portions indicate the ranges in which ink discharging holes of the respective ink jet heads are formed.

The continuous paper W, which is guided by the guide rollers 201 to 209 from unillustrated paper feeding unit and in-feed unit, is overprinted by the four ink jet head units described above with four colors of inks, namely, cyan, magenta, yellow, and black in this order from the upstream side in the running direction, indicated by an arrow K, of the continuous paper W. The continuous paper W printed by the printer 11 passes through an unillustrated out-feed unit, is cut into a certain size by an unillustrated after-treatment device, and comes out as a printed product by being folded as needed.

The guide rollers 204 to 208 of the printer 11 are guide device for guiding the continuous paper W to a certain position immediately below the ink discharging surfaces F of the ink jet head units H110 to H140. The guide rollers 204 to 208 are disposed such that the continuous paper W contacts their circumferential surfaces at a slight winding angle (see FIG. 4).

The shaft ends of the guide rollers 204 to 208 are rotatably supported on the frame T. The frame T is attached on rods of four air cylinders V which are attached on the frames 111 and 112 of the printer 11 via a bracket. It is possible to lift the frame T upward or downward in the vertical direction by extruding or retracting the rods of the four air cylinders V at the same time.

When the frame T is lifted upward, the circumferential surfaces of the guide rollers 204 to 208 move to a certain position m (see FIG. 1A) close to the ink discharging surfaces F, enabling the continuous paper W guided by the guide rollers 204 to 208 to be guided to the printing position, immediately below the ink discharging surfaces F, at which printing is performed. When the frame T is lifted downward, the guide rollers 204 to 208 move to a position n (see FIG. 2A and FIG. 3A) apart from the ink discharging surfaces F, forming a space around the ink discharging surfaces F to enable a maintenance work for the ink discharging surface F to be performed. In FIG. 4, the guide rollers 204 to 208 existing at the position m and the continuous paper W guided by them are shown by two-dot chain lines. Then, when ink receptacles C1 of an ink receiving device C to be described later face the ink discharging surfaces F, the guide rollers 204 to 208 are moved to the position n.

The ink receiving device C provided in the printer 11 includes ink receptacles C1 and a support member C2 which supports the ink receptacles C1 in a manner to enable the ink receptacles C1 to be moved to the standby position r (see FIGS. 1), the ink receiving position s (see FIGS. 2), and the maintenance position t (see FIGS. 3). A first ink receptacle moving unit G1 for moving the ink receptacles C1 to the ink receiving position s and the standby position r comprises an air cylinder G10, and the printer 11 has an auxiliary frame 113.

In the present embodiment, one side across the running path of the continuous paper W of the printer 11 at which the frame 111 is provided is an operation side at which a worker operates the printing devices including the printer 11 during printing. The auxiliary frame 113 is provided at one side across the running path of the continuous paper W opposite to the operation side, i.e., at a drive side at which the frame 112 of the printer 11 is provided, such that the auxiliary frame 113 is parallel with the frame 112.

The support member C2 comprises two slide rails C21 and a frame C22. The slide rails C21 are of a three-stage type in which an intermediate rail C212 exists between a fixed rail C211 as a fixed member and a moving rail C213 as a moving member. Hence, the moving rail C213 can move to a position slightly away from the fixed rail C211 lengthwise.

To be more specific, the fixed rail C211, the moving rail C213, and the intermediate rail C212 have approximately the same length. A load imposed on the moving rail C213 is supported by the fixed rail C211 through the intermediate rail C212. The fixed rail C211 and the intermediate rail C212, and the intermediate rail C212 and the moving rail C213 can slide with respect to each other in their lengthwise direction.

The intermediate rail C212 can protrude from the fixed rail C211 by sliding with respect to the fixed rail C211, by a length slightly longer than half its length, to one direction and to the opposite direction from a position at which the intermediate rail C212 and the fixed rail C211 positionally approximately coincide in their lengthwise direction. Further, the moving rail C213 can protrude from the intermediate rail C212 by sliding with respect to the intermediate rail C212, by a length slightly longer than half its length, to one direction and to the opposite direction from a position at which the moving rail C213 and the intermediate rail C212 positionally approximately coincide in their lengthwise direction. Accordingly, the moving rail C213 can protrude by moving with respect to the fixed rail C211, by a length slightly longer than its length, to one direction and to the opposite direction from a position at which the moving rail C213 and the fixed rail C211 positionally approximately coincide in their lengthwise direction.

The sliding surfaces of the rails sliding with respect to each other are formed as steel ball rolling surfaces, and a steel ball held by a holding device is installed between the steel ball rolling surfaces sliding with respect to each other. Since the rails slide by rolling of the steel ball, the sliding resistance is small.

The fixed rails C211 of the slide rails C21 are attached on two stays J1 which are provided between the frame 111 and the frame 112 of the printer 11 to be orthogonal to the running direction of the continuous paper W. The two slide rails C21 are provided horizontally, in parallel with each other, and such that they face each other at the same position. The frame C22 is attached to extend between the moving rails C213 of the two slide rails C21, and integrated with the two moving rails C213.

In the slide rails C21, the position at which the moving rail C213 approximately coincides with the fixed rail C211 in its moving direction (at which also the intermediate rail C212 approximately coincides) is the ink receiving position s of the ink receptacles C1 attached on the frame C22.

When the ink receptacles C1 attached on the frame C22 are at the maintenance position t, the intermediate rail C212 protrudes from the fixed rail C211 toward the operation side of the printer 11 by a length slightly longer than half its length, and the moving rail C213 protrudes from the intermediate rail C212 toward the operation side of the printer 11 by a length slightly longer than half its length, i.e., the moving rail C213 reaches a position slightly away from the fixed rail C211 lengthwise at the operation side of the printer 11 and thereby supports the ink receptacles C1 which are attached on the frame C22 while partially protruding outward from the frame 111.

On the other hand, when the ink receptacles C1 attached on the frame C22 are at the standby position r, the intermediate rail C212 protrudes from the fixed rail C211 toward the drive side of the printer 11 by a length slightly longer than half its length, and the moving rail C213 protrudes from the intermediate rail C212 toward the drive side of the printer 11 by a length slightly longer than half its length, i.e., the moving rail C213 reaches a position slightly away from the fixed rail C211 lengthwise to protrude to between the frame 112 and the auxiliary frame 113 at the drive side of the printer 11 and thereby to support the ink receptacles C1 attached on the frame C22.

The ink receptacles C1 have a box shape having no top. The number of ink receptacles C1 provided is four, which correspond one-to-one to the ink jet head units H110 to H140. The ink receptacles C1 are attached on the frame C22. Each ink receptacle C1 has a discarding hole from which received ink is discarded. A hose C11 (a part thereof at the downstream side in the ink flowing direction is not shown) through which ink is guided to a waste ink tank (not shown) is connected to the discarding hole. The bottom surface of the ink receptacle C1 is inclined so that received ink converges to the discarding hole. The hose C11 connects the ink receptacle C1 to the waste ink tank by having a length enough to follow the ink receptacle C1 wherever of the standby position r, the ink receiving position s, and the maintenance position t the ink receptacle C1 moves to.

The first ink receptacle moving unit G1 for moving the ink receptacles C1 of the ink receiving device C to the ink receiving position s and the standby position r comprises the air cylinder G10. The air cylinder G10 is provided between the frame 112 and the auxiliary frame 113 in parallel with the moving direction of the slide rails C21, and attached at both ends thereof on the frame 112 and the auxiliary frame 113 via a bracket. The leading end of its rod can be easily linked to or released from the frame C22 by a configuration described below.

By retracting its rod while the leading end of the rod is linked to the frame C22, the air cylinder G10 positions the ink receptacles C1 attached on the frame C22 such that the ink receptacles C1 are in a state allowing the ink jet head units H110 to H140 to print on the continuous paper W, i.e., such that the ink receptacles C1 are at the standby position r (see FIGS. 1) defined between the frame 112 and the auxiliary frame 113 at which the ink receptacles C1 do not disturb the continuous paper .W from running. By extruding the rod, the air cylinder G10 moves the four ink receptacles C1 attached on the frame C22 to be positioned at the ink receiving position s (see FIGS. 2) at which the ink receptacles C1 face the ink discharging surfaces F of the ink jet head units H110 to H140 respectively. By releasing the portion at which the frame C22 and the leading end of the rod of the air cylinder G10 are attached, it is possible to manually move the ink receptacles C1 together with the frame C22 from the ink receiving position s to the maintenance position t (see FIGS. 3).

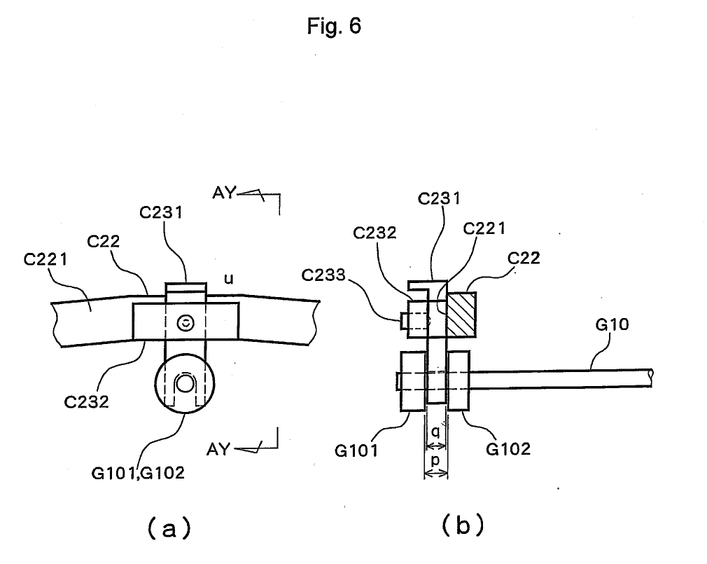

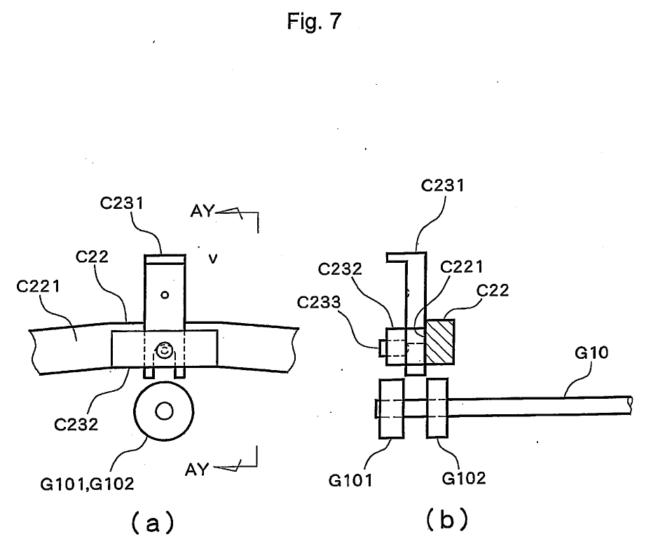

Next, the portion at which the frame C22 and the leading end of the rod of the air cylinder G10 are attached will be described in detail with reference to FIG. 6 and FIG. 7. A sub-diagram (a) of FIG. 6 shows FIG. 2A seen with the sight line directed to the direction of an arrow AX. A sub-diagram (b) of FIG. 6 is a sectional diagram of the sub-diagram (a) taken at the position of AY-AY and seen with the sight line directed to the direction of arrows. FIG. 6 shows a state in which a linking bar C231 is at a linking position u. FIG. 7 shows a state in which the linking bar C231 of FIG. 6 is at a releasing position v. A sub-diagram (b) of FIG. 7 is a sectional diagram of a sub-diagram (a) taken at the position of AY-AY and seen with the sight line directed to the direction of arrows.

The air cylinder G10 has two flanges G101 and G102, which are attached at the leading end of its rod with a gap p therebetween. On the other hand, the frame C22 has a gate-shaped fitting C232, which is attached at the center portion of its side surface C221 on the operation side of the printer 11 in its moving direction, and through which the linking bar C231 is inserted.

The linking bar C231 can be manually moved upward and downward, and can be moved to the linking position u at which it links the frame 022 to the rod of the air cylinder G10 through the gate-shaped fitting C232, and to the releasing position v at which it releases the link between the frame C22 and the rod of the air cylinder G10.

The thickness q of the linking bar C231 is slightly smaller than the gap p between the flanges G101 and G102, and an upside-down U-shaped cut is formed in the bottom end of the linking bar C231. The width of the upside-down U-shaped cut is slightly larger than the diameter of the rod of the air cylinder G10. When the linking bar is lowered to the linking position u, the bottom end of the linking bar C231 lets in the rod of the air cylinder G10 into the upside-down U-shaped cut, and the linking bar is inserted between the flanges G101 and G102, whereby the frame C22 and the rod of the air cylinder G10 are linked. At this time, the ball of a ball plunger C233 attached on the gate-shaped fitting C232 falls in a recess opened at a predetermined position of the linking bar C231, thus preventing the linking bar C231 from coming out of place in the vertical direction.

When the linking bar C231 is manually lifted upward to the releasing position v against the ball pressing force of the ball plunger C233 fallen in the recess of the linking bar 231, the bottom end of the linking bar slips out from between the flanges G101 and G102, and the frame C22 is released from the link with the rod of the air cylinder G10. When the linking bar C231 is lifted upward to the releasing position v, the ball of the ball plunger C233 attached on the gate-shaped fitting C232 protrudes into the upside-down U-shaped cut of the linking bar C231, thus preventing the linking bar from falling down by its own weight. Once the linking bar is positioned at the releasing position v, the frame C22 can be moved manually to move the ink receptacles C1 from the ink receiving position s to the maintenance position t and from the maintenance position t to the ink receiving position s.

The first ink receptacle moving unit G1 according to the present embodiment is configured to realize the movement of the frame C22 manually for performing the operation of moving the ink receptacles C1 from the ink receiving position s to the maintenance position t and from the maintenance position t to the ink receiving position s. However, a second ink receptacle moving unit G2 explained next can by itself enable also the movement between the maintenance position t and the ink receiving position s, without any manual operation.

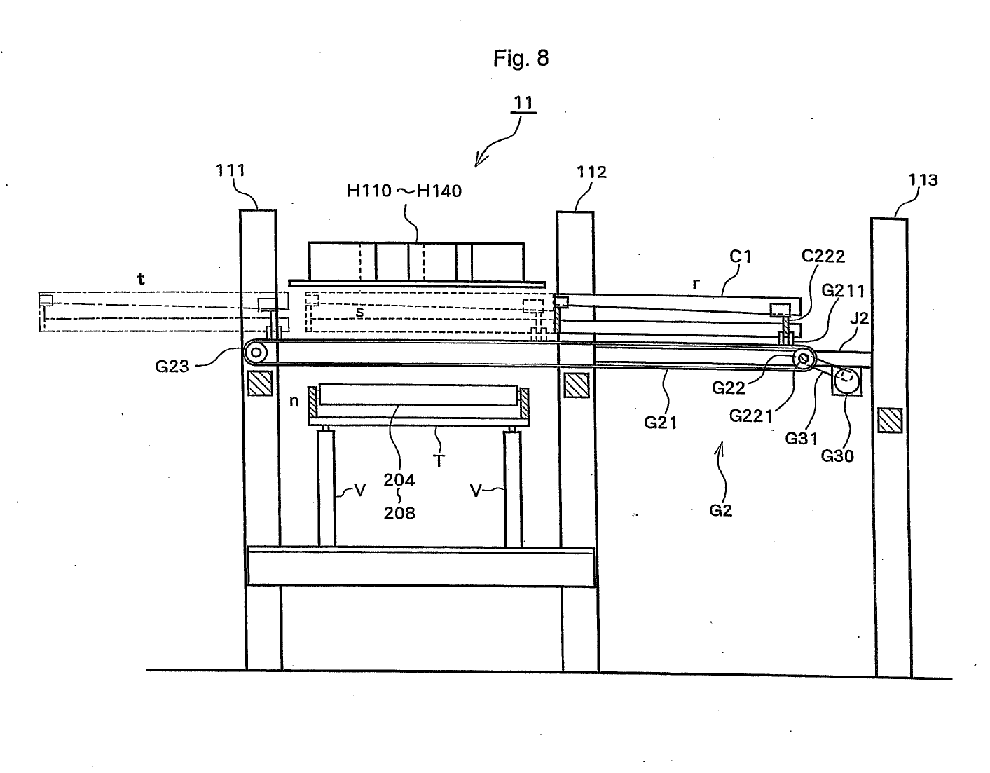

From now, an embodiment employing the second ink receptacle moving unit. G2 will be explained. FIG. 8 is a schematic diagram showing a sectional view of the printer 11 taken orthogonally to the running direction of the continuous paper W to show the embodiment employing the second ink receptacle moving unit G2. The position at which the ink receptacles C1 are drawn by a solid line is the standby position r. The position at which the ink receptacles C1 are drawn by a broken line is the ink receiving position s. The position at which the ink receptacles C1 are drawn by a dashed line is the maintenance position t. The hoses for guiding ink from the ink receptacles to the waste ink tank are not shown.

In the second ink receptacle moving unit G2 shown in FIG. 8, endless chains or belts (hereinafter, described as “belts”) G21 are tensed near the two slide rails C21 respectively, by pulleys G22 and G23 in parallel with the moving direction of the moving rails S213. The belts G21 each have an attachment G211, which is joined to a side plate C222 of the frame C22, which side plate C222 exists on the drive side of the printer 11 in the moving direction of the frame C22.

A shaft G211 on which the pulley G22 shown in FIG. 8 and a pulley G22 not shown as it exists closer to the viewer side of FIG. 8 are fixed is rotatably supported to extend between two stays J2 (one of which is not shown as it exists closer to the viewer side of FIG. 8) which are provided between the frame 112 and the auxiliary frame 113. The shaft G211 can rotate in the normal direction and in the reverse direction upon receiving rotation transmitted from the output side of a motor G30 through a drive belt G31. The pulleys G23 are rotatably supported by the frame 111.

The motor G30 rotates the pulleys G22 fixed on the shaft G221 to drive the belts G21, thereby enabling the ink receptacles C1 to be moved along the slide rails C21 through the attachments G211 and the frame C22.

The second ink receptacle moving unit G2 shown in FIG. 8 may further comprise a motor control device (not shown), and a first limit switch (not shown), a second limit switch (not shown), and a third limit switch (not shown) which are connected to the motor control device for sending signals thereto such that when the ink receptacles C1 move to the standby position the first limit switch detects the position of the attachments G211 corresponding to the standby position r, when the ink receptacles C1 move to the ink receiving position s, the second limit switch detects the position of the attachments G211 corresponding to the ink receiving position s, and when the ink receptacles C1 move to the maintenance position t, the third limit switch detects the position of the attachments G211 corresponding to the maintenance position t. With this configuration, when the ink receptacles C1, which have existed at the standby position r, the ink receiving position s, or the maintenance position t, arrive at adjoining another position in response to an operation given to start moving the ink receptacles C1 to the intended position (the operation may be a switch operation on a control panel belonging to the control device), any of the first to third limit switches outputs an attachments detected signal, which is received by the motor control device, which hence controls the motor to stop, thereby enabling the ink receptacles C1 to be positioned at the standby position r, the ink receiving position s, or the maintenance position t.

The ink receiving device C described above is operated as follows, for example. Note that the following explanation is about a case when the ink receptacle moving unit is the first ink receptacle moving unit G1 shown in FIG. 1A to FIG. 7, unless otherwise indicated.

The ink receptacles C1 are kept positioned at the standby position r, unless the ink jet head units H110 to H140 perform ink purge or a worker performs a maintenance work of the ink receptacles C1. By keeping the ink receptacles C1 positioned at the standby position r, it is possible to start printing anytime, and besides, to prevent the ink receptacles C1 from disturbing the worker who moves along the operation side of the series of printing devices.

When the ink receptacles C1 are at the standby position r, the linking bar C231 of the frame C22 is at the linking position u at which it is inserted between the flanges G101 and G102, and the rod of the air cylinder G10 is retracted.

When performing ink purge, the printer 11 is suspended from printing, if it is under printing. Then, the guide rollers 204 to 208 are lowered to the position n together with the frame T, by retracting the rods of the air cylinders V of the printer 11. If the continuous paper W is currently passed through the interior of the printer 11, also the continuous paper W lowers by its own weight onto the circumferential surfaces of the guide rollers 204 to 208.

After the guide rollers 204 to 208 are lowered to the position n, the rod of the air cylinder G10 is extruded. As the rod extends, the ink receptacles C1 attached on the frame C22 of the support member C2 move from the standby position r to the ink receiving position s by accompanying the linking bar C231 sandwiched between the flanges G101 and G102, and are positioned there.

After this, ink purge is carried out in all of the ink jet head units H110 to H140, or in any ink jet head unit that requires ink purge to be carried out. Purged ink is received into the ink receptacles C1 corresponding to the respective ink jet head units H110 to H140, and a majority of the received ink flows through the hoses C11 connected to the ink receptacles C1 to be received in the waste ink tank not shown.

When starting printing immediately after the ink purge is carried out, the rod of the air cylinder G10 is retracted to move the ink receptacles C1 attached on the frame C22 of the support member C2 from the ink receiving position s to the standby position r together with the linking bar C231 sandwiched between the flanges G101 and G102. When the movement of the ink receptacles C1 to the standby position r is completed, the rods of the air cylinders V of the printer 11 are extruded to lift the guide rollers 204 to 208 upward to the position m together with the frame T, and printing is started.

On the other hand, when performing a maintenance work of the ink receptacles C1, the rods of the air cylinders V of the printer 11 are retracted while the printer 11 is not performing printing, to lower the guide rollers 204 to 208 to the position n together with the frame T. After this, the rod of the air cylinder G10 is extruded to move the ink receptacles C1 attached on the support member C2 from the standby position r to the ink receiving position s. (Note that the ink receptacles C1 already exist at the ink receiving position s, when performing a maintenance work of the ink receptacles C1 immediately after ink purge.)

Next, the linking bar C231 provided on the frame C22 is manually lifted upward from the linking position u to the releasing position v against the ball pressing force of the ball plunger C233 fallen in place in the recess opened in the linking bar C231. Then, the ball of the ball plunger C233 protrudes into the upside-down U-shaped cut of the linking bar C231 to prevent the linking bar from falling down by its own weight, keeping the linking bar C231 at the releasing position v even after a hand is taken off therefrom.

By the linking bar C231 being positioned at the releasing position v, the frame C22 and the ink receptacles C1 attached on the frame C22 are released from the link with the first ink receptacle moving unit G1, and hence can be moved to the maintenance position t manually.

The slide rails C21 are provided with stoppers which prohibit the moving rails C213 from moving by more than a predetermined stroke, thus preventing the moving rails C213 and the intermediate rails C212 from coming off from the fixed rails. Therefore, the position of the frame C22 and the ink receptacles C1 at which they are approximately completely drawn out manually toward the operation side of the printer 11 is defined as the maintenance position t.

By being positioned at the maintenance position t, the ink receptacles C1 appear at the operation side of the printer 11 from below the ink discharging surfaces F of the ink jet head units H110 to H140, which enables a maintenance work to be easily performed, such as removal of ink left in the ink receptacles C1, removal of paper dust attached around the ink receptacles C1, etc.

After the maintenance work of the ink receptacles C1 is completed, the frame C22 and the ink receptacles C1 are moved to the ink receiving position s manually. The linking bar C231, which is held at the releasing position v with the ball of the ball plunger C233 protruding into the upside-down U-shaped cut of the linking bar C231, is inserted manually, against the ball pressing force of the ball plunger C233, between the flanges G101 and G102 attached on the extruded rod of the air cylinder G10 to be brought to the linking position u. With the linking bar C231 brought to the linking position u, the frame C22 and the ink receptacles C1 are linked to the first ink receptacle moving unit G1, and hence retracting the rod of the air cylinder G10 causes the frame C22 and the ink receptacles C1 to move to the standby position r.

After the movement of the ink receptacles C1 to the standby position r is completed, the rods of the air cylinders V of the printer 11 are extruded to lift the guide rollers 204 to 208 to the position m together with the frame T to prepare for printing.

Next, the case when the ink receptacle moving unit is the second ink receptacle moving unit G2 shown in FIG. 8 and comprises the motor control device and the first to third limit switches for detecting the positions of the attachments G211 corresponding to the standby position r, the ink receiving position s, and the maintenance position t will be explained. The role of the ink receptacles C1 does not change wherever of the standby position r, the ink receiving position s, and the maintenance position t they exist. Therefore, a brief explanation about their role will be given.

When performing ink purge, the printer 11 is suspended from printing if it is under printing, and the guide rollers 204 to 208 are lowered to the position n.

An operation of moving the ink receptacles C1 positioned at the standby position r to the ink receiving position s, i.e., an operation of rotating the output shaft of the motor G30 counterclockwise (hereinafter described as “left-handedly”) in FIG. 8 is given from the motor control device (hereinafter, the terms “left-handedly” and “right-handedly” will refer to the directions of rotation when the FIG. 8 is seen from a position perpendicular to the drawing sheet). In response to the rotation of the output shaft of the motor G30, the shaft G221 linked to this output shaft by the drive belt G31 and the pulleys G22 fixed on the shaft G221 are also rotated left-handedly. In response to the rotation of the pulleys G22, the attachments G211 attached on the belts G21 move leftward, and together with the frame C22 of the support member C2 joined to the attachments, the ink receptacles C1 move from the standby position r toward the ink receiving position s. When the ink receptacles C1 arrive at the ink receiving position s, the second limit switch not shown outputs a signal upon detecting the position of the attachments G211 corresponding to the ink receiving position s, and the motor control device receives the signal and stops the motor, thereby positioning the ink receptacles C1 at the ink receiving position s.

After this, ink purge is carried out in the ink head jet units H110 to H140. When starting printing immediately after the ink purge is carried out, an operation of moving the ink receptacles C1 positioned at the ink receiving position s to the standby position r, i.e., an operation of rotating the output shaft of the motor G30 clockwise (hereinafter described as “right-handedly”) is given from the motor control device. In response to the rotation of the output shaft of the motor G30, the shaft G221 linked to this output shaft by the drive belt G31 and the pulleys G22 fixed on the shaft G221 are also rotated right-handedly. In response to the rotation of the pulleys G22, the attachments G211 attached on the belts G21 move rightward, and together with the frame C22 of the support member C2 joined to the attachments, the ink receptacles C1 move toward the standby position r. When the ink receptacles C1 arrive at the standby position r, the first limit switch not shown outputs a signal upon detecting the position of the attachments G211 corresponding to the standby position r, and the motor control device receives the signal and stops the motor, thereby positioning the ink receptacles C1 at the standby position r.

After the movement of the ink receptacles C1 to the standby position r is completed, the guide rollers 204 to 208 of the printer 11 are lifted upward to the position m to start printing.

When performing a maintenance work of the ink receptacles C1, the guide rollers 204 to 208 of the printer 11 are lowered to the position n while the printer 11 is not performing printing, and after this, an operation of moving the ink receptacles C1 positioned at the standby position r to the ink receiving position s is given from the motor control device like as described above. The ink receptacles C1 move from the standby position r to the ink receiving position s, the second limit switch outputs a signal upon detecting the position of the attachments G211 corresponding to the ink receiving position s, and the motor control device receives the signal and stops the motor, thereby positioning the ink receptacles C1 at the ink receiving position s (note that the ink receptacles C1 already exist at the ink receiving position s, when performing a maintenance work of the ink receptacles C1 immediately after ink purge).

Then, an operation of moving the ink receptacles C1 positioned at the ink receiving position s to the maintenance position t, i.e., an operation of rotating the output shaft of the motor G30 left-handedly is given from the motor control device. In response to the rotation of the output shaft of the motor G30, the pulleys G22 are also rotated left-handedly, the attachments G211 attached on the belts G21 move leftward, and together with the frame C22 of the support member C2 joined to the attachments, the ink receptacles C1 move from the ink receiving position s toward the maintenance position t. When the ink receptacles C1 arrive at the maintenance position t, the third limit switch not shown outputs a signal upon detecting the position of the attachments G211 corresponding to the maintenance position t, the motor control device receives the signal and stops the motor, thereby positioning the ink receptacles C1 at the maintenance position t. Hence, the maintenance work of the ink receptacles C1 is performed.

After the maintenance work of the ink receptacles C1 is completed, in order to move the ink receptacles C1 to the standby position r, first, an operation of moving the ink receptacles C1 positioned at the maintenance position t to the ink receiving position s, i.e., an operation of rotating the output shaft of the motor G30 right-handedly is given from the motor control device. In response to the rotation of the output shaft of the motor G30, the pulleys G22 are also rotated right-handedly, the attachments G211 attached on the belts G21 move rightward, and together with the frame C22 of the support member C2 joined to the attachments, the ink receptacles C1 move from the maintenance position t toward the ink receiving position s. When the ink receptacles C1 arrive at the ink receiving position s, the second limit switch not shown outputs a signal upon detecting the position of the attachments G211 corresponding to the ink receiving position s, and the motor control device receives the signal and stops the motor, thereby positioning the ink receptacles C1 at the ink receiving position s.

Continuously, an operation of moving the ink receptacles C1 positioned at the ink receiving position s to the standby position r, i.e., an operation of rotating the output shaft of the motor G30 right-handedly is given from the motor control device. In response to the rotation of the output shaft of the motor G30, the pulleys G22 are also rotated right-handedly, the attachments G211 attached on the belts G21 move rightward, and together with the frame C22 of the support member C2 joined to the attachments, the ink receptacles C1 move from the ink receiving position s toward the standby position r. When the ink receptacles C1 arrive at the standby position r, the first limit switch not shown outputs a signal upon detecting the position of the attachments G211 corresponding to the standby position r, and the motor control device receives the signal and stops the motor, thereby positioning the ink receptacles C1 at the standby position r.

When the ink receptacles C1 are moved to the maintenance position t by the second ink receptacle moving unit G2 or manually, the ink receptacles C1 pass under the ink jet head units H110 to H140 to appear at the operation side of the printer 11, which is a position where a worker can easily perform a maintenance work such as cleaning, etc.

The moving rails C213 of the slide rails C21 supporting the ink receptacles C1 at the maintenance position t protrude to be away from the fixed rails C211 lengthwise with the aid of the intermediate rails C212. When the ink receptacles C1 are moved to the ink receiving position s and the standby position r, the intermediate rails C212 and the moving rails C213 having protruded recede and do not remain outside the printer 11 at the operation side.

Preferred embodiments of the present invention have thus been described. As described above, according to the ink receiving device for an ink-jet-printer use of the present invention, the standby position at which the ink receptacles sit during printing is at the drive side that is opposite, with respect to the running path of the continuous paper, to the operation side at which a worker operates the printing devices, and hence operations to be given to the series of printing devices will not be disturbed during printing.

When performing a maintenance work of the ink receptacles, the ink receptacles can be moved to the maintenance position defined at the operation side of the printer. Therefore, as compared with a case of performing a maintenance work of ink receptacles existing at a standby position, a worker needs not bother going to the ink receptacles existing at the standby position by taking a roundabout way to avoid the paper path running from the paper feeding unit to the after-treatment unit.

Further, a maintenance work can be performed extremely smoothly because it can be done at the operation side of the printer and not at the drive side thereof at which the work efficiency is poor because motors for driving the rollers of the in-feed unit and the adjoining out-feed unit, wirings for connecting the motors to the control panel, ducts for accommodating wirings connected to the ink jet heads of the printing unit and ink pipes, etc. are provided.

Further, when the ink receptacles are positioned at the maintenance position, they are supported by the moving rails which protrude from the fixed rails attached inside the printer frames. When the ink receptacles are moved to the ink receiving position and the standby position, the moving rails having protruded also recede together with the ink receptacles from the maintenance position to the ink receiving position and the standby position. The ink receptacle moving unit is provided between the frame provided at the operation side of the printer and the auxiliary frame provided at the drive side of the printer. Therefore, when the ink receptacles are at the ink receiving position and the standby position, the support member of the ink receiving device and the ink receptacle moving unit are not protruding outward from the printer beyond the operation-side frame of the printer. Therefore, a worker who moves at the operation side of the printer is not disturbed.

When the ink receiving device for ink-jet-printer use according to the present invention is provided with the first ink receptacle moving unit, the ink receptacles can be moved to and positioned at the standby position, which is hard to reach a hand to from the operation side, and the ink receiving position.

When the ink receiving device for ink-jet-printer use according to the present invention is provided with the second ink receptacle moving unit, the ink receptacles can be moved to and positioned at the standby position, the ink receiving position, and the maintenance position.

Preferred embodiments of the present invention have thus been described, but the technical scope of the present invention is not limited to the scope of description in the above embodiments. Various changes or improvements can be made to the above embodiments. It is clear from the descriptions in the claims that embodiments including such changes or improvements can also be included in the technical scope of the present invention.

What is claimed is:

1. An ink receiving device for an ink jet printer, provided for receiving ink discharged for a purpose other than printing from an ink jet head of a line head type ink jet printer which prints on a running continuous print medium by discharging ink from the ink jet head of which ink discharging surface is faced with a top surface of the print medium, the ink receiving device comprising:
an ink receptacle which receives ink discharged from a nozzle of the ink jet head; and
a support member which supports the ink receptacle in a manner to enable the ink receptacle to move horizontally, wherein the ink receptacle is enabled by the support member to move horizontally to three positions including:
a standby position at which the ink receptacle does not disturb the ink jet head from printing on the print medium;
an ink receiving position which is below the ink discharging surface of the ink jet head, and at which the ink receptacle receives ink discharged for a purpose other than printing; and
a maintenance position which is different from the ink receiving position and the standby position, and at which a maintenance work of the ink receptacle is performed.

2. The ink receiving device for the ink jet printer according to claim 1,
wherein the standby position and the maintenance position exist on different sides of the print medium in its widthwise direction, oppositely with respect to a running path of the print medium.

3. The ink receiving device for the ink jet printer according to claim 1,
wherein the support member includes at least:
a fixed member which is fixed inside the ink jet printer; and
a moving member which is able to move by being guided by the fixed member and on which the ink receptacle is attached.

4. The ink receiving device for the ink jet printer according to claim 1, comprising
an ink receptacle moving unit which moves the ink receptacle at least between the ink receiving position and the standby position.
